(19) United States
(12) Patent Application Publication
(10) Pub. No.: US 2015/0372772 A1
(43) Pub. Date: Dec. 24, 2015

(54) METHOD AND APPARATUS FOR RECEIVING SIGNAL IN WIRELESS COMMUNICATION SYSTEM

(71) Applicant: LG ELECTRONICS INC., Seoul (KR)

(72) Inventors: Hyungtae KIM, Seoul (KR); Seungmin LEE, Seoul (KR); Inkwon SEO, Seoul (KR); Hanbyul SEO, Seoul (KR)

(73) Assignee: LG ELECTRONICS INC., Seoul (KR)

(21) Appl. No.: 14/741,937

(22) Filed: Jun. 17, 2015

Related U.S. Application Data
(60) Provisional application No. 62/014,097, filed on Jun. 18, 2014.

(51) Int. Cl. H04B 15/00; H04L 5/00; H04L 1/16; H04W 72/04

(52) U.S. Cl. CPC H04B 15/00; H04W 72/0446; H04L 5/0048; H04L 1/1614; H04W 88/02

(57) ABSTRACT

Disclosed is a wireless communication system. A method for receiving a signal using NAICS (Network Assisted Interference Cancellation and Suppression) in a wireless access system supporting eIMTA (Enhanced Interference Management and Traffic Adaptation) includes receiving first information on uplink and downlink configuration of a neighbor cell and second information related with a flexible subframe of the neighbor cell, and receiving the signal based on the first information and the second information.

### CROSS-REFERENCE TO RELATED APPLICATIONS

Pursuant to 35 U.S.C. §119(e), this application claims the benefit of U.S. Provisional Patent Application Ser. Nos. 62/014,097, filed on Jun. 18, 2014, the contents of which are hereby incorporated by reference herein in its entirety.

### TECHNICAL FIELD

The present invention relates to a wireless communication system, and more particularly, to a method and apparatus for receiving signal using NAICS in a wireless communication system supporting eIMTA.

### BACKGROUND ART

A 3rd generation partnership project long term evolution (3GPP LTE) communication system will be described below as an exemplary mobile communication system to which the present invention is applicable.

FIG. 1 is a diagram schematically showing a network structure of an evolved universal mobile telecommunications system (E-UMTS) as an exemplary radio communication system. The E-UMTS system has evolved from the conventional UMTS system and basic standardization thereof is currently underway in the 3GPP. The E-UMTS may be generally referred to as a long term evolution (LTE) system. For details of the technical specifications of the UMTS and E-UMTS, refer to Release 7 and Release 8 of “3rd generation partnership project; technical specification group radio access network”.

Referring to FIG. 1, the E-UMTS includes a user equipment (UE), eNBs (or eNode Bs or base stations), and an access gateway (AG) which is located at an end of a network (E-UTRAN) and connected to an external network. The eNBs may simultaneously transmit multiple data streams for a broadcast service, a multicast service, and/or a unicast service.

One or more cells may exist per eNB. A cell is set to use one of bandwidths of 1.25, 2.5, 5, 10, 15, and 20 MHz to provide a downlink or uplink transport service to several UEs. Different cells may be set to provide different bandwidths. The eNB controls data transmission and reception for a plurality of UEs. The eNB transmits downlink scheduling information with respect to downlink data to notify a corresponding UE of a time/frequency domain in which data is to be transmitted, coding, data size, and hybrid automatic repeat and request (HARQ)-related information. In addition, the eNB transmits uplink scheduling information with respect to UL data to a corresponding UE to inform the UE of an available time/frequency domain, coding, data size, and HARQ-related information. An interface for transmitting user traffic or control traffic may be used between eNBs. A core network (CN) may include the AG, a network node for user registration of the UE, and the like. The AG manages mobility of a UE on a tracking area (TA) basis, wherein one TA includes a plurality of cells.

Although radio communication technology has been developed up to LTE based on wideband code division multiple access (WCDMA), the demands and expectations of users and providers continue to increase. In addition, since other radio access technologies continue to be developed, new technology is required to secure competitiveness in the future. For example, decrease of cost per bit, increase of service availability, flexible use of a frequency band, simple structure, open interface, and suitable power consumption by a UE are required.

A UE periodically and/or aperiodically reports current channel state information (CSI) to a BS in order to help effective management of a wireless communication system of the BS. The reported CSI contains results calculated in consideration various situations, and thus, there is a need for a more effective reporting method.

### DISCLOSURE

### Technical Problem

An object of the present invention devised to solve the problem lies in a method and device for receiving signal using NAICS in a wireless communication system supporting eIMTA.

It is to be understood that both the foregoing general description and the following detailed description of the present invention are exemplary and explanatory and are intended to provide further explanation of the invention as claimed.

### Technical Solution

The object of the present invention can be achieved by providing a method for receiving a signal using NAICS (Network Assisted Interference Cancellation and Suppression) in a wireless access system supporting eIMTA (Enhanced Interference Management and Traffic Adaptation), the method including receiving first information on uplink and downlink configuration of a neighbor cell and second information related with a flexible subframe of the neighbor cell, and receiving the signal based on the first information and the second information.

In another aspect of the present invention, provided herein is a user equipment for receiving a signal using NAICS (Network Assisted Interference Cancellation and Suppression) in a wireless access system supporting eIMTA (Enhanced Interference Management and Traffic Adaptation), the user equipment including radio frequency (RF) units, and a processor, wherein the processor is configured to receive first information on uplink and downlink configuration of a neighbor cell and second information related with a flexible subframe of the neighbor cell, and receive signal based on the first information and the second information.

The second information may include a bitmap indicating flexible subframe position of the neighbor cell.

The second information may include a downlink reference configuration to be compared with the uplink and downlink configuration of the neighbor cell.

The second information may include a first subframe set information for flexible subframe and a second subframe set information for static downlink subframe.

The method further includes receiving a first NAICS parameter set for the first subframe set information and a second NAICS parameter set for the second first subframe set information.

The second information includes intended subframe configuration indicating subframes used by the neighbor cell until reference timing point.

The flexible subframe indicates uplink subframe or special subframe which can be used by being exchanged with downlink subframe for the eIMTA.

### Advantageous Effects

According to embodiments of the present invention, signal may be received more effectively reported using NAICS in a wireless communication system supporting eIMTA.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 is a diagram schematically showing a network structure of an evolved universal mobile telecommunications system (E-UMTS) as an exemplary radio communication system;

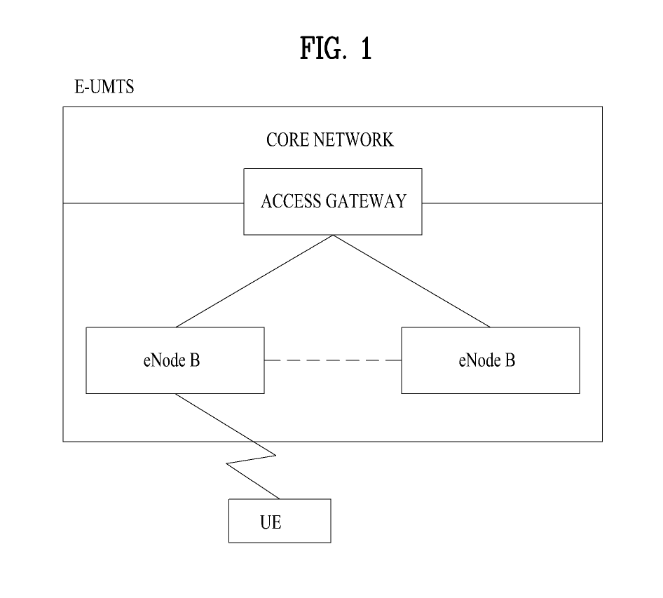

FIG. 2 is a diagram illustrating a control plane and a user plane of a radio interface protocol between a UE and an evolved universal terrestrial radio access network (E-UTRAN) based on a 3rd generation partnership project (3GPP) radio access network standard;

FIG. 3 is a diagram showing physical channels used in a 3GPP system and a general signal transmission method using the same;

FIG. 4 is a diagram illustrating an example of the structure of a radio frame used in a long term evolution (LTE) system;

FIG. 5 is a diagram illustrating a control channel included in a control region of a subframe in a downlink radio frame;

FIG. 6 is a diagram illustrating an uplink subframe structure used in an LTE system;

FIG. 7 illustrates the configuration of a typical multiple input multiple output (MIMO) communication system;

FIGS. 8, 9, 10 and 11 illustrate periodic reporting of channel state information (CSI);

FIGS. 12 and 13 illustrate an exemplary process for periodically reporting CSI when a non-hierarchical codebook is used;

FIG. 14 is a diagram illustrating periodic reporting of CSI when a hierarchical codebook is used;

FIG. 15 illustrates a general interference environment of a downlink system;

FIG. 16 illustrates a SIB UL/DL configuration and a DL reference configuration of interference TP.;

FIG. 17 is a diagram illustrating a base station (BS) and a user equipment (UE) to which an embodiment of the present invention is applicable.

### BEST MODE

The configuration, operation and other features of the present invention will be understood by the embodiments of the present invention described with reference to the accompanying drawings. The following embodiments are examples of applying the technical features of the present invention to a 3rd generation partnership project (3GPP) system.

Although, for convenience, the embodiments of the present invention are described using the LTE system and the LTE-A system in the present specification, the embodiments of the present invention are applicable to any communication system corresponding to the above definition. In addition, although the embodiments of the present invention are described based on a Frequency Division Duplex (FDD) scheme in the present specification, the embodiments of the present invention may be easily modified and applied to a Half-Duplex FDD (H-FDD) scheme or a Time Division Duplex (TDD) scheme.

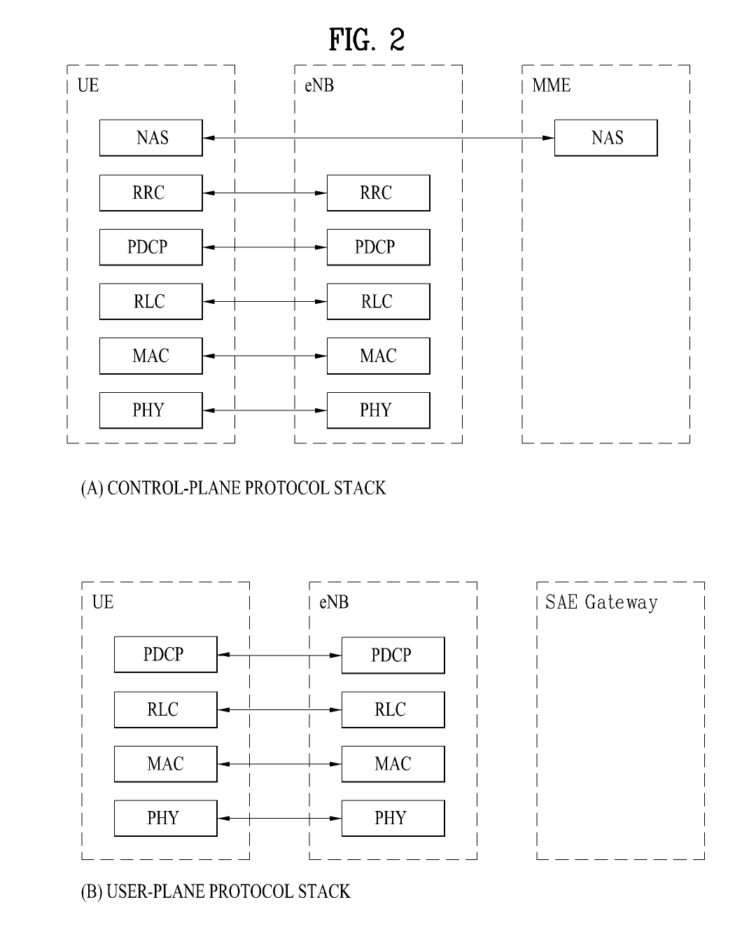

FIG. 2 is a diagram illustrating a control plane and a user plane of a radio interface protocol between a UE and an evolved universal terrestrial radio access network (E-UTRAN) based on a 3GPP radio access network standard. The control plane refers to a path used for transmitting control messages used for managing a call between the UE and the network. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on a higher layer via a transport channel. Data is transported between the MAC layer and the PHY layer via the transport channel. Data is also transported between a physical layer of a transmitting side and a physical layer of a receiving side via a physical channel. The physical channel uses a time and a frequency as radio resources. More specifically, the physical channel is modulated using an orthogonal frequency division multiple access (OFDMA) scheme in downlink and is modulated using a single-carrier frequency division multiple access (SC-FDMA) scheme in uplink.

A medium access control (MAC) layer of a second layer provides a service to a radio link control (RLC) layer of a higher layer via a logical channel. The RLC layer of the second layer supports reliable data transmission. The function of the RLC layer may be implemented by a functional block within the MAC. A packet data convergence protocol (PDCP) layer of the second layer performs a header compression function to reduce unnecessary control information for efficient transmission of an Internet protocol (IP) packet such as an IPv4 packet or an IPv6 packet in a radio interface having a relatively small bandwidth.

A radio resource control (RRC) layer located at the bottom of a third layer is defined only in the control plane and is responsible for control of logical, transport, and physical channels in association with configuration, re-configuration, and release of radio bearers (RBs). The RB is a service that the second layer provides for data communication between the UE and the network. To accomplish this, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A Non-Access Stratum (NAS) layer located above the RRC layer performs functions such as session management and mobility management.

One cell of the eNB is set to use a bandwidth such as 1.25, 2.5, 5, 10, 15 or 20 MHz to provide a downlink or uplink transmission service to several UEs. Different cells may be set to provide different bandwidths.

Downlink transport channels for transmission of data from the network to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through a downlink SCH and may also be transmitted through a downlink multicast channel (MCH). Uplink transport channels for transmission of data from the UE to the network include a random access channel (RACH) for transmission of initial control messages and an uplink SCH for transmission of user traffic or control messages. Logical channels, which are located above the transport channels and are mapped to the transport channels, include a broadcast control channel (BCCH), a paging control channel (PCCH), a common control channel (CCCH), a multicast control channel (MCCH), and a multicast traffic channel (MTCH).

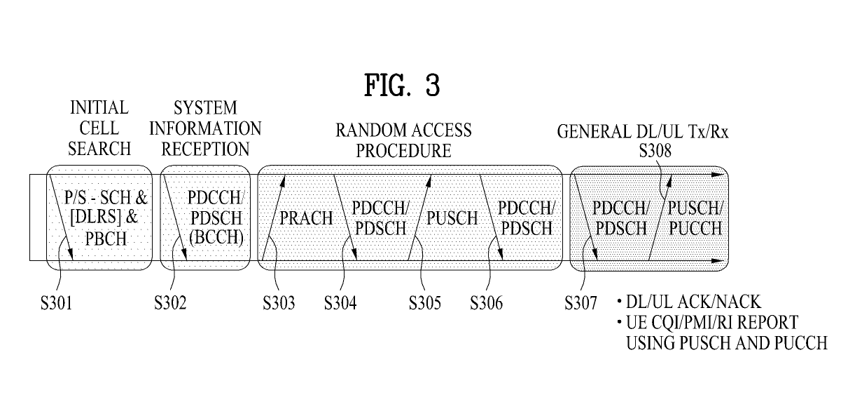

FIG. 3 is a diagram showing physical channels used in a 3GPP system and a general signal transmission method using the same.

A UE performs an initial cell search operation such as synchronization with an eNB when power is turned on or the UE enters a new cell (S301). To this end, the UE may receive a Primary synchronization channel (P-SCH) and a secondary synchronization channel (S-SCH) from the eNB, perform synchronization with the eNB, and acquire information such as a cell ID. Thereafter, the UE may receive a physical broadcast channel from the eNB so as to acquire broadcast information within the cell. Meanwhile, the UE may receive a Downlink Reference Signal (DL RS) so as to confirm a downlink channel state in the initial cell search step.

The UE which completes the initial cell search may receive a Physical Downlink Control Channel (PDCCH) and a Physical Downlink Shared Channel (PDSCH) according to information included in the PDCCH so as to acquire more detailed system information (S302).

Meanwhile, if the eNB is initially accessed or radio resources for signal transmission are not present, the UE may perform a Random Access Procedure (RACH) (step S303 to S306) with respect to the eNB. To this end, the UE may transmit a specific sequence through a Physical Random Access Channel (PRACH) as a preamble (S303 and S305), and receive a response message of the preamble through the PDCCH and the PDSCH corresponding thereto (S304 and S306). In the case of contention-based RACH, a contention resolution procedure may be further performed.

The UE which performs the above procedures may perform PDCCH/PDSCH reception (S307) and physical uplink shared channel (PUSCH)/physical uplink control channel (PUCCH) transmission (S308) as a general uplink/downlink signal transmission procedure. In particular, the UE receives downlink control information (DCI) through the PDCCH. Here, the DCI contains control information such as resource allocation information about a UE and has different formats according to according to different usages of DCI.

The control information transmitted from the UE to the eNB in uplink or transmitted from the eNB to the UE in downlink includes a downlink/uplink ACK/NACK signal, a channel quality indicator (CQI), a precoding matrix index (PMI), a rank indicator (RI), and the like. In the case of the 3GPP LTE system, the UE may transmit the control information such as CQI/PMI/RI through the PUSCH and/or the PUCCH.

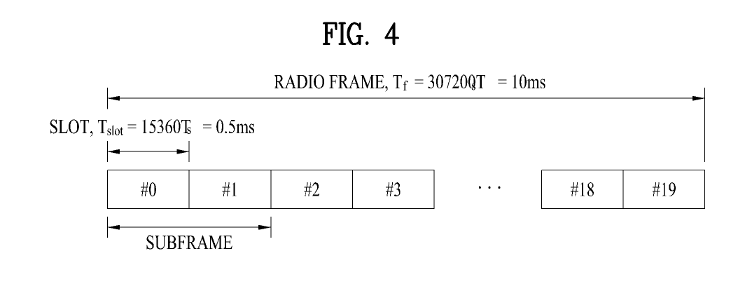

FIG. 4 is a diagram illustrating an example of the structure of a radio frame used in an LTE system.

Referring to FIG. 4, a radio frame has a length of 10 ms (327200×Ts) and includes ten subframes having an equal size. Each subframe has a length of 1 ms and includes two slots each having a length of 0.5 ms (15360×Ts). Here, Ts denotes a sampling time, which is represented as Tx=1/(15 kHz×2048)=3.2552×10⁻⁸ (approximately 33 ns). A slot includes a plurality of orthogonal frequency division multiplexing (OFDM) symbols in the time domain and a plurality of resource blocks in the frequency domain. In the LTE system, one resource block includes 12 subcarriers×7(6) OFDM symbols. A unit time for transmitting data, transmission time interval (TTI), may be set to one or more subframes. The above-described radio frame structure is exemplary and the number of subframes included in the radio frame, the number of slots included in one subframe, and the number of OFDM symbols or SC-FDMA symbols included in each slot may be changed in various manners.

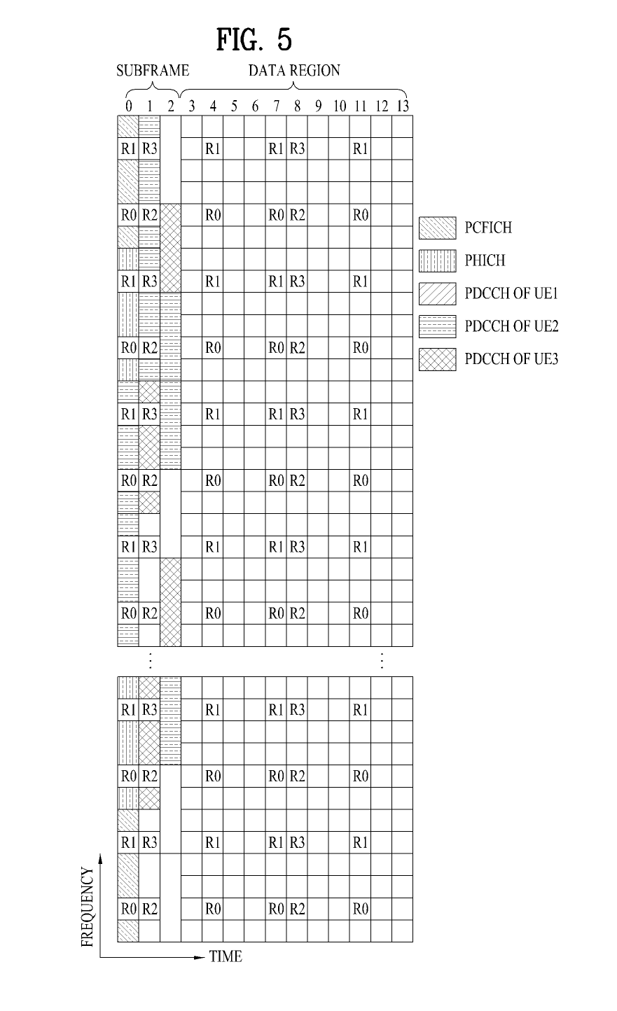

FIG. 5 is a diagram illustrating a control channel included in a control region of a subframe in a downlink radio frame.

Referring to FIG. 5, a subframe includes 14 OFDM symbols. The first to third OFDM symbols are used as a control region and the remaining 13 to 11 OFDM symbols are used as a data region, according to subframe settings. In FIG. 5, R1 to R4 denote reference signals (RS) or pilot signals for antennas 0 to 3. The RS is fixed to a constant pattern within a subframe regardless of the control region and the data region. A control channel is allocated to resources, to which the RS is not allocated, in the control region, and a traffic channel is also allocated to resources, to which the RS is not allocated, in the control region. Examples of the control channel allocated to the control region include a physical control format indicator channel (PCFICH), physical hybrid-arq indicator channel (PHICH), physical downlink control channel (PDCCH), etc.

The physical control format indicator channel (PCFICH) informs the UE of the number of OFDM symbols used for the PDCCH per subframe. The PCFICH is located at a first OFDM symbol and is set prior to the PHICH and the PDCCH. The PCFICH includes four resource element groups (REGs) and the REGs are dispersed in the control region based on a cell identity (ID). One REG includes four resource elements (REs). An RE indicates a minimum physical resource defined as one subcarrier x one OFDM symbol. The PCFICH has a value of 1 to 3 or 2 to 4 and is modulated using a quadrature phase shift keying (QPSK) scheme.

The physical Hybrid-ARQ indicator channel (PHICH) is used to transmit HARQ ACK/NACK for uplink transmission. That is, the PHICH refers to a channel in which DL ACK/NACK information for UL HARQ is transmitted. The PHICH includes one REG and is scrambled on a cell-specific basis. ACK/NACK is indicated by one bit and is modulated using binary phase shift keying (BPSK). The modulated ACK/NACK is spread with a spreading factor (SF) of 2 or 4. A plurality of PHICHs mapped to the same resource constitutes a PHICH group. The number of multiplexed PHICHs in the PHICH group is determined according to the number of SFs. The PHICH (group) is repeated through times in order to acquire diversity gain in the frequency domain and/or time domain.

The physical downlink control channel (PDCCH) is allocated to the first n OFDM symbols of a subframe. Here, n is an integer of 1 or more and is indicated by a PCFICH. The PDCCH includes one or more control channel elements (CCEs). The PDCCH informs each UE or a UE group of information associated with resource allocation of a paging channel (PCH) and a downlink-shared channel (DL-SCH), both of which are transport channels, uplink scheduling grant, HARQ information, etc. The paging channel (PCH) and the downlink-shared channel (DL-SCH) are transmitted through a PDSCH. Accordingly, the eNB and the UE transmit and receive data through the PDSCH except for specific control information or specific service data.

Information indicating to which UE (one or a plurality of UEs) data of the PDSCH is transmitted and information indicating how the UEs receive and decode the PDSCH data are transmitted in a state of being included in the PDCCH. For example, it is assumed that a specific PDCCH is CRC-masked with a Radio Network Temporary Identity (RNTI) “A”, and information about data transmitted using radio resource (e.g., frequency location) “B” and transmission format information (e.g., transmission block size, modulation scheme, coding information, or the like) “C” is transmitted via a specific subframe. In this case, one or more UEs located within a cell monitor a PDCCH using its own RNTI information, and if one or more UEs having “A” RNTI are present, the UEs receive the PDCCH and receive the PDSCH indicated by “B” and “C” through the information about the received PDCCH.

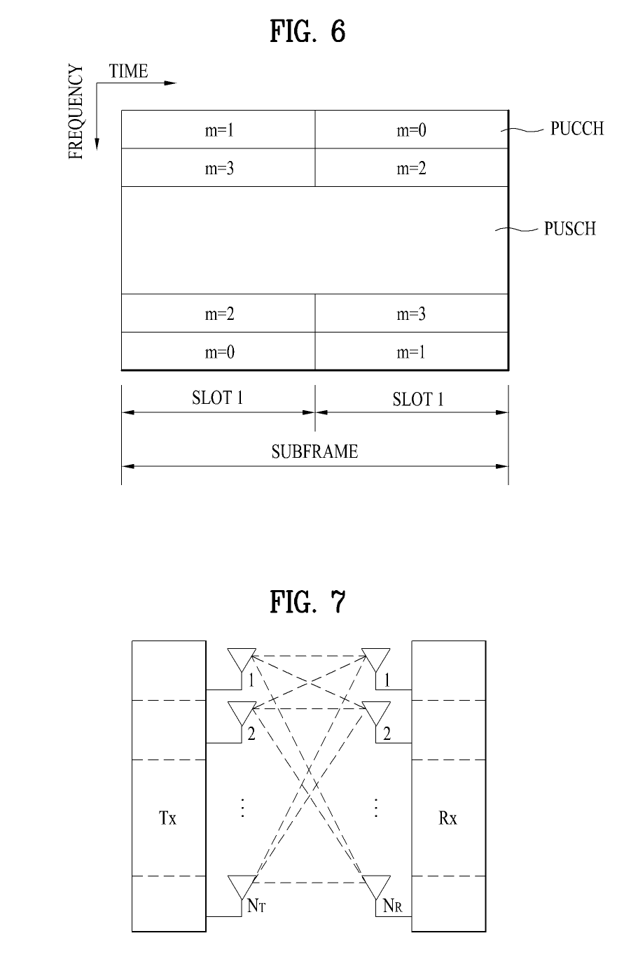

FIG. 6 is a diagram illustrating an uplink subframe structure used in an LTE system.

Referring to FIG. 6, a UL subframe may be divided into a region to which physical uplink control channel (PUCCH) for carrying control information is allocated and a region to which physical uplink shared channel (PUSCH) for carrying user data is allocated. The middle of the subframe is allocated to the PUSCH, while both sides of the data region in the frequency domain are allocated to the PUCCH. Control information transmitted on the PUCCH may include a Hybrid Automatic Repeat request acknowledgement/negative acknowledgement (HARQ ARCK/NACK), a Channel Quality Indicator (CQI) representing a downlink channel state, a rank indicator (RI) for multiple input multiple output (MIMO), a scheduling request (SR) requesting uplink resource allocation. A PUCCH for one UE uses one resource block that occupies different frequencies in slots in a subframe. That is, two resource blocks allocated to the PUCCH is frequency hopped at a slot boundary. In particular, PUCCHs with m=0, m=1, and m=2 are allocated to a subframe in FIG. 6.

Multiple Input Multiple Output (MIMO) System

Now a description will be given of a Multiple Input Multiple Output (MIMO) system. MIMO can increase the transmission and reception efficiency of data by using a plurality of transmission (Tx) antennas and a plurality of reception (Rx) antennas. That is, with the use of multiple antennas at a transmitter or a receiver, MIMO can increase capacity and improve performance in a wireless communication system. The term “MIMO” is interchangeable with “multi-antenna”.

The MIMO technology does not depend on a single antenna path to receive a whole message. Rather, it completes the message by combining data fragments received through a plurality of antennas. MIMO can increase data rate within a cell area of a predetermined size or extend system coverage at a given data rate. In addition, MIMO can find its use in a wide range including mobile terminals, relays, etc. MIMO can overcome a limited transmission capacity encountered with the conventional single-antenna technology in mobile communication.

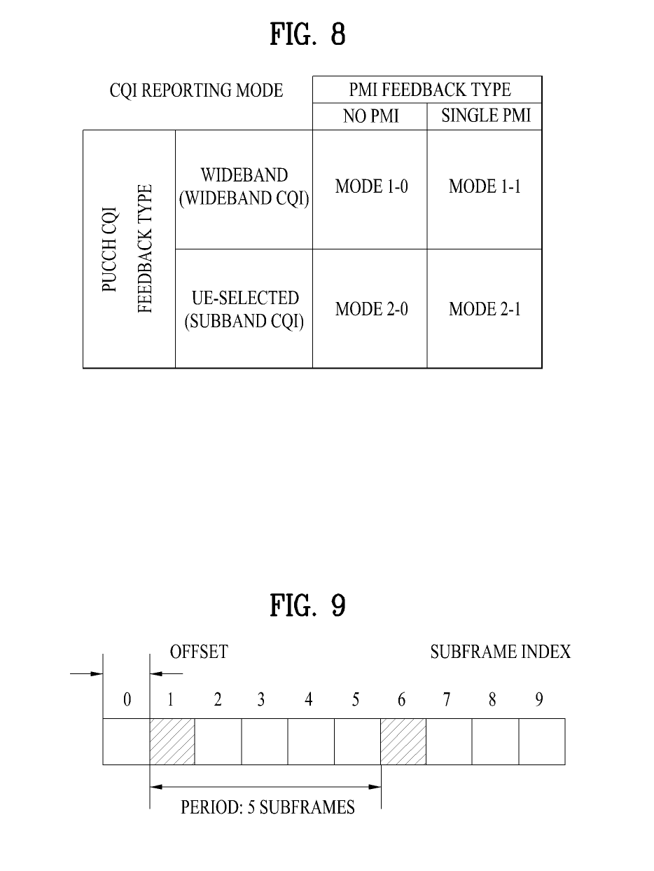

FIG. 7 illustrates the configuration of a typical MIMO communication system. Referring to FIG. 7, a transmitter has N_{T} Tx antennas and a receiver has N_{R} Rx antennas. The simultaneous use of a plurality of antennas at both the transmitter and the receiver increases a theoretical channel transmission capacity, compared to use of a plurality of antennas at only one of the transmitter and the receiver. The channel transmission capacity increases in proportion to the number of antennas. Therefore, transmission rate and frequency efficiency are increased. Given a maximum transmission rate Rₒ that may be achieved with a single antenna, the transmission rate may be increased, in theory, to the product of Rₒ and a transmission rate increase rate Rᵢ in the case of multiple antennas. Rᵢ is the smaller value between N_{T} and N_{R}.

Rᵢ=min(N_{T},N_{R}) [Equation 1]

For instance, a MIMO communication system with four Tx antennas and four Rx antennas may achieve a four-fold increase in transmission rate theoretically, relative to a single-antenna system. Since the theoretical capacity increase of the MIMO system was verified in the middle 1990s, many techniques have been actively proposed to increase data rate in real implementation. Some of the techniques have already been reflected in various wireless communication standards for 3G mobile communications, future-generation wireless local area network (WLAN), etc.

Concerning the research trend of MIMO up to now, active studies are underway in many respects of MIMO, inclusive of studies of information theory related to calculation of multi-antenna communication capacity in diverse channel environments and multiple access environments, studies of measuring MIMO radio channels and MIMO modeling, studies of time-space signal processing techniques to increase transmission reliability and transmission rate, etc.

Communication in a MIMO system with N_{T} Tx antennas and N_{R} Rx antennas as illustrated in FIG. 7 will be described in detail through mathematical modeling. Regarding a transmission signal, up to N_{T} pieces of information can be transmitted through the N_{T} Tx antennas, as expressed as the vector shown in Equation 2 below.

s=└s₁,s₂, . . . ,s_{N}_{_{T}}┘^{T} [Equation 2]

A different transmission power may be applied to each piece of transmission information, s₁,s₂, . . . ,s_{N}_{_{T}}. Let the transmission power levels of the transmission information be denoted by P₁,P₂, . . . ,P_{N}_{_{T}}, respectively. Then the transmission power-controlled transmission information vector is given as

ŝ=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Equation 3]

The transmission power-controlled transmission information vector ŝ may be expressed as follows, using a diagonal matrix P of transmission power.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

N_{T} transmission signals x₁,x₂, . . . ,x_{N}_{_{T}} may be generated by multiplying the transmission power-controlled information vectors ŝ a weight matrix W. The weight matrix W functions to appropriately distribute the transmission information to the Tx antennas according to transmission channel states, etc. These N_{T} transmission signals x₁,x₂, . . . ,x_{N}_{_{T}} are represented as a vector x, which may be determined by Equation 5 below. Herein, wᵢⱼ denotes a weight between a j^{th} piece of information and an i^{th} Tx antenna and W is referred to as a weight matrix or a precoding matrix.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

In general, the rank of a channel matrix is the maximum number of different pieces of information that can be transmitted on a given channel, in its physical meaning. Therefore, the rank of a channel matrix is defined as the smaller between the number of independent rows and the number of independent columns in the channel matrix. The rank of the channel matrix is not larger than the number of rows or columns of the channel matrix. The rank of a channel matrix H, rank(H) satisfies the following constraint.

rank(H)≦min(N_{T},N_{R}) [Equation 6]

A different piece of information transmitted in MIMO is referred to as ‘transmission stream’ or shortly ‘stream’. The ‘stream’ may also be called ‘layer’. It is thus concluded that the number of transmission streams is not larger than the rank of channels, i.e. the maximum number of different pieces of transmittable information. Thus, the channel matrix H is determined by

# of streams≦rank(H)≦min(N_{T},N_{R}) [Equation 7]

“# of streams” denotes the number of streams. One thing to be noted herein is that one stream may be transmitted through one or more antennas.

One or more streams may be mapped to a plurality of antennas in many ways. The stream-to-antenna mapping may be described as follows depending on MIMO schemes. If one stream is transmitted through a plurality of antennas, this may be regarded as spatial diversity. When a plurality of streams is transmitted through a plurality of antennas, this may be spatial multiplexing. Needless to say, a hybrid scheme of spatial diversity and spatial multiplexing in combination may be contemplated.

Channel State Information (CSI) Feedback

Channel State Information (CSI) reporting will be described below. In the current LTE standard, there are two MIMO transmission schemes, open-loop MIMO operating without channel information and closed-loop MIMO operating with channel information. Particularly in the closed-loop MIMO, each of an eNB and a UE may perform beamforming based on CSI to obtain the multiplexing gain of MIMO Tx antennas. To acquire CSI from the UE, the eNB may transmit a reference signal (RS) to the UE and may command the UE to feed back measured CSI on a PUCCH or PUSCH.

CSI is classified largely into three information types, RI, PMI, and CQI. An RI is information about a channel rank, as described before. The channel rank is the number of streams that a UE can receive in the same time-frequency resources. Because the RI is determined mainly according to the long-term fading of a channel, the RI may be fed back to an eNB in a longer period than a PMI and a CQI.

A PMI is the index of a UE-preferred eNB precoding matrix determined based on a metric such as signal to interference and noise ratio (SINR), reflecting the spatial characteristics of channels. A CQI represents a channel strength. In general, the CQI reflects a reception SINR that the eNB can achieve with a PMI.

An advanced system such as an LTE-A system considers achievement of an additional multi-user diversity by the use of Multi-User MIMO (MU-MIMO). Due to the existence of interference channels between UEs multiplexed in an antenna domain in MU-MIMO, the accuracy of CSI may significantly affect interference with other multiplexed UEs as well as a UE that reports the CSI. Accordingly, more accurate CSI than in Single User MIMO (SU-MIMO) should be reported in MU-MIMO.

In this context, the LTE-A standard designs a final PMI separately as a long-term and/or wideband PMI, W1 and a short-term and/or subband PMI, W2.

For example, the long-term covariance matrix of channels expressed as Equation 8 below may be used for hierarchical codebook transformation that configures one final PMI with W1 and W2.

W=norm(W1 W2) [Equation 8]

In Equation 8 above, W2 is a short-term PMI, which is a codeword of a codebook reflecting short-term channel information, W is a codeword of a final codebook, and norm(A) is a matrix obtained by normalizing the norm of each column of matrix A to 1.

Conventionally, the codewords W1 and W2 are given as Equation 9 below.

$$W 1 ( i ) = [ \begin{matrix}{X}_{i} & 0 \\ 0 & {X}_{i}\end{matrix} ] , \qquad [ Equation 9 ]$$

where Xᵢ is Nt/2 by M matrix.

$$W 2 ( j ) = \overbrace{[ \begin{matrix}{e}_{M}^{k} & {e}_{M}^{l} \\ {α}_{j} {e}_{M}^{k} & {β}_{j} {e}_{M}^{l}\end{matrix} … \begin{matrix}{e}_{M}^{m} \\ {γ}_{j} {e}_{M}^{m}\end{matrix} ]}^{r columns}$$

(if rank=r), where 1≦k,l,m≦M and k,l,m are integer.

Here, Nt is the number of Tx antennas and M is the number of columns of a matrix Xi, which means that the matrix Xi has total M candidate column vectors. e_{M}^{k}, e_{M}^{l}, and e_{M}^{m} are column vectors that have elements of 0 except for only kₜₕ, lₜₕ, and mₜₕ elements that are 1 among M elements and are kₜₕ, lₜₕ, and mₜₕ column vectors of Xi. αⱼ, βⱼ, and γⱼ are complex values and indicate that phase rotation is applied to the kₜₕ, lₜₕ, and mₜₕ column vectors of the matrix in order to choose these column vectors, respectively. i is an integer equal to or greater than 0 and is a PMI index indicating W1. j is an integer equal to or greater than 0 and is a PMI index indicating W2.

In Equation 9 above, the codewords are designed so as to reflect correlation characteristics between established channels, if cross polarized antennas are arranged densely, for example, the distance between adjacent antennas is equal to or less than a half of a signal wavelength. The cross polarized antennas may be divided into a horizontal antenna group and a vertical antenna group and the two antenna groups are co-located, each having the property of a uniform linear array (ULA) antenna.

Therefore, the correlations between antennas in each group have the same linear phase increment property and the correlation between the antenna groups is characterized by phase rotation. Since a codebook is eventually quantized values of channels, it is necessary to design a codebook, reflecting channel characteristics. For the convenience of description, a rank-1 codeword designed in the above manner may be given as Equation 10 below.

$$W 1 ( i ) * W 2 ( j ) = [ \begin{matrix}{X}_{i} ( k ) \\ {α}_{j} {X}_{i} ( k )\end{matrix} ] \qquad [ Equation 10 ]$$

In [Equation 10], a codeword is expressed as an N_{T}×1 vector where N_{T} is the number of Tx antennas and the codeword is composed of an upper vector Xᵢ(k) and a lower vector αⱼXᵢ(k), representing the correlation characteristics of the horizontal and vertical antenna groups, respectively. Preferably, Xᵢ(k) is expressed as a vector having the linear phase increment property, reflecting the correlation characteristics between antennas in each antenna group. For example, a Discrete Fourier Transform (DFT) matrix may be used for Xᵢ(k).

As described above, CSI in an LTE system includes, but is not limited to, CQI, PMI, and RI. Some or all of CQI, PMI, and RI may be transmitted according to a transmission mode of a UE. A case in which CSI is periodically transmitted is referred to as periodic reporting and a case in which CSI is transmitted according to request of a BS is referred to as aperiodic reporting. In case of aperiodic reporting, a request bit contained in UL scheduling information from the BS is transmitted to the UE. Then, the UE transmits CSI obtained in consideration of a transmission mode of the UE to the BS via a UL data channel (PUSCH). In case of periodic reporting, periods, offset for a corresponding period, etc. are signaled in units of subframes via an upper layer signal for each respective UE in a semi-static manner. Each UE transmits CSI obtained in consideration of a transmission mode of the UE to the BS via a UL control channel (PUCCH) according to a predetermined period. When UL data and CSI are simultaneously present in a subframe for transmitting CSI, the CSI is transmitted through a UL data channel (PUSCH) together with the data. The BS transmits transmission timing information appropriate for each respective UE to the UE in consideration of a channel state of each UE, a distribution state of UEs in a cell, etc. The transmission timing information includes a period, offset, etc. for transmission of CSI and may be transmitted to each UE through an RRC message.

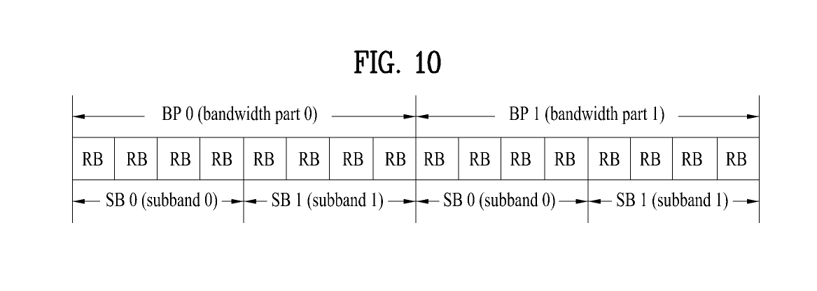

FIGS. 8 to 11 illustrate periodic reporting of CSI in LTE.

Referring to FIG. 8, an LTE system has four CQI reporting modes. In detail, the CQI reporting mode is classified into WB CQI and SB CQI according to a CQI feedback type and is classified into no PMI and single PMI according to whether PMI is transmitted. Each UE receives information formed by combining a period and offset via RRC signaling in order to periodically report CQI.

FIG. 9 illustrates an example in which a UE transmits CSI when information indicating {period ‘5’ and offset ‘1’} is signaled to the UE. Referring to FIG. 9, upon receiving the information indicating {period ‘5’ and offset ‘1’}, the UE transmits CSI in units of 5 subframes with an offset of one subframe in a direction in which a subframe index increases from a 0ₜₕ subframe. CSI. CSI is basically transmitted via a PUCCH. However, when PUSCH for transmission is present at the same time, CSI is transmitted together with data via PUSCH. A subframe index is formed by combining a system frame number (or a radio frame index)(nf) and a slot index (ns, 0 to 19). Since a subframe includes 2 slots, a subframe index may be defined according to 10*nf+floor(ns/2). floor( ) indicates a rounddown function.

There are a type for transmitting only WB CQI and a type for both WB CQI and SB CQI. In case of the type for transmitting only WB CQI, CQI information about an entire band in a subframe corresponding to every CQI transmission period is transmitted. As illustrated in FIG. 8, when PMI needs to be also transmitted according to a PMI feedback type, PMI information is transmitted together with CQI information. In case of the type for transmitting both WB CQI and SB CQI, WB CQI and SB CQI are alternately transmitted.

FIG. 10 is a diagram illustrating an exemplary system having a system band with 16 RBs. In this case, it is assumed that the system band includes two bandwidth parts (BPs) BP0 and BP1 which each include two subbands SB0 and SB1 which each include four RBs. This assumption is purely exemplary for explanation. The number BPs and the size of each SB may vary according to the size of the system band. In addition, the number of SBs included in each BP may vary according to the number of RBs, the number of BPs, and the size of SB.

In case of the type for transmission both WB CQI and SB CQI, WB CQI is transmitted in a first CQI transmission subframe, and CQI about an SB having a better channel state from SB0 and SB1, belonging to BP0, and an index (e.g., a subband selection indicator (SSI) corresponding to the corresponding SB are transmitted in a next CQI transmission subframe. Then, CQI about an SB having a better channel state from SB0 and SB1, belonging to BP1, and an index corresponding to the corresponding SB is transmitted in a next transmission subframe. Likewise, after WB CQI is transmitted, CQI information about BPs is sequentially transmitted. CQI information about each BP between two WB CQIs may be sequentially transmitted once to four times. For example, when CQI information about each BP between two WB CQIs is sequentially transmitted once, CQI information may be transmitted in an order of WB CQI [symbol] BP0 CQI [symbol] BP1 CQI [symbol] WB CQI. In addition, when CQI information about each BP between two WB CQIs is sequentially transmitted four times, CQI information may be transmitted in an order of WB CQI [symbol] BP0 CQI [symbol] BP1 CQI [symbol] BP0 CQI [symbol] BP1 CQI [symbol] BP0 CQI [symbol] BP1 CQI [symbol] BP0 CQI [symbol] BP1 CQI [symbol] WB CQI. Information about a number of times that each BP CQI is sequentially transmitted is signaled in an upper layer (e.g., an RRC layer).

FIG. 11(a) is a diagram illustrating an example in which a UE transmits both WB CQI and SB CQI when information indicating {period ‘5’ and offset ‘1’} is signaled to the UE. Referring to FIG. 11(a), CQI may be transmitted in only a subframe corresponding to signaled period and offset irrespective a type of CQI. FIG. 11(b) illustrates a case in which RI is additionally transmitted in a case of FIG. 11(a). RI may be signaled from an upper layer (e.g., an RRC layer) via a combination of a multiple of WB CQI transmission period and offset in the corresponding transmission period. Offset of RI is signaled as a relative value based on offset of CQI. For example, when the offset of CQI is ‘1’ and the offset of RI is ‘0’, RI may have the same offset as CQI. The offset of RI is defined as 0 and a negative value. In detail, FIG. 11(b) assumes a case in which a RI transmission period is one time of a WB CQI transmission period and the offset of RI is ‘−1’ in the same environment as in FIG. 11(a). Since the RI transmission period is one time of the WB CQI transmission period, transmission periods of CSI are actually the same. Since the offset of RI is ‘−1’, RI is transmitted based on ‘−1’ (that is, subframe #0) with respect to offset ‘1’ of CQI in FIG. 11(a). When the offset of RI is ‘0’, transmission subframes of WB CQI and RI overlap each other. In this case, WB CQI is dropped and RI is transmitted.

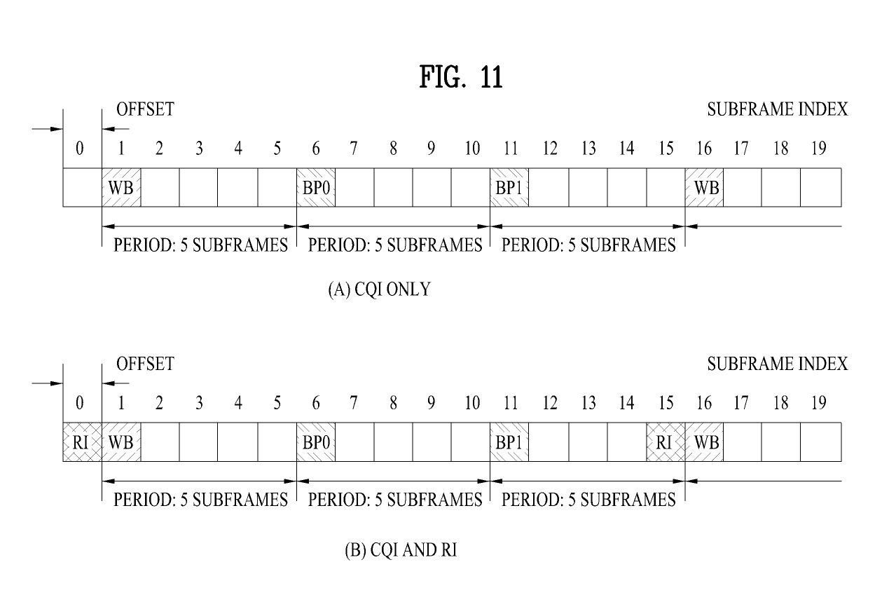

FIG. 12 is a diagram illustrating CSI feedback in case of Mode 1-1 of FIG. 8.

Referring to FIG. 12, the CSI feedback is composed of transmission of two types of report contents, Report 1 and Report 2. In detail, RI is transmitted in Report 1 and WB PMI and WB CQI are transmitted in Report 2. Report 2 is transmitted in a subframe with a subframe index satisfying (10*nf+floor(ns/2)−N offset, CQI)mod(Npd)=0. N offset, CQI corresponds to an offset value for transmission of PMI/CQI illustrated in FIG. 9. FIG. 12 illustrates a case of N offset, CQI=1. Npd 5 is a subframe interval between adjacent Reports 2. FIG. 12 illustrates a case of Npd=2. Report 1 is transmitted in a subframe with a subframe index satisfying (10*nf+floor(ns/2)−N offset, CQI-N offset, RI)mod(MRI*Npd)=0. M_{RI} is determined via upper layer signaling. In addition, N offset, RI corresponds to a relative offset value for transmission of RI illustrated in FIG. 11. FIG. 12 illustrates a case of M_{RI}=4 and N offset, RI=−1.

FIG. 13 is a diagram illustrating CSI feedback in case of Mode 2-1 illustrated in FIG. 8.

Referring to FIG. 13, the CSI feedback is composed of transmission of three types of report contents, Report 1, Report 2, and Report 3. In detail, RI is transmitted in Report 1, WB PMI and WB CQI are transmitted in Report 2, and subband (SB) CQI and L-bit subband selection indicator (SSI) are transmitted in Report 3. Report 2 or Report 3 is transmitted in a subframe with a subframe index satisfying (10*nf+floor(ns/2)−N offset, CQI)mod(Npd)=0. In particular, Report 2 is transmitted in a subframe with a subframe index satisfying (10*nf+floor(ns/2)−N offset, CQI)mod(H*Npd)=0. Thus, Report 2 is transmitted every interval of H*Npd and subframes between adjacent Reports 2 are filled by transmitting Report 3. In this case, H satisfies H=J*K+1, where J is the number of bandwidth parts (BPs). K indicates the number of continuously-performed full cycles for selecting a subband for each of different BPs once and transmitting subbands over all BPs and is determined via upper layer signaling. FIG. 13 illustrates a case of Npd=2, J=3, and K=1. Report 1 is transmitted in a subframe with a subframe index satisfying (10*nf+floor(ns/2)−N offset, CQI-N offset, RI)mod(MRI*(J*K+1)*Npd)=0. FIG. 13 illustrates a case of M_{RI}=2 and N offset, RI=−1.

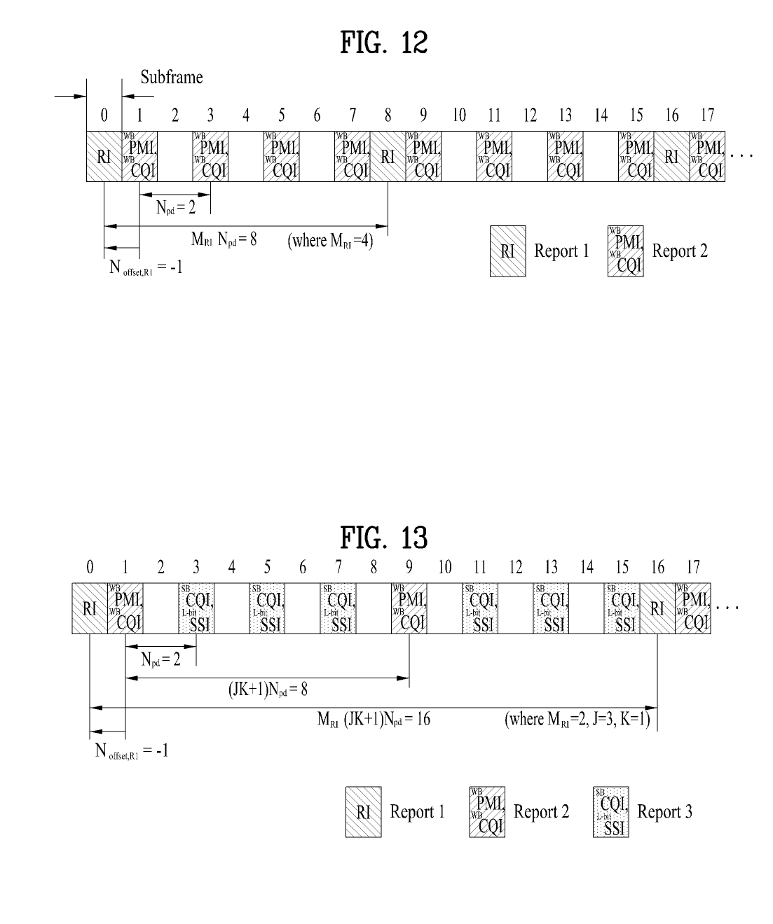

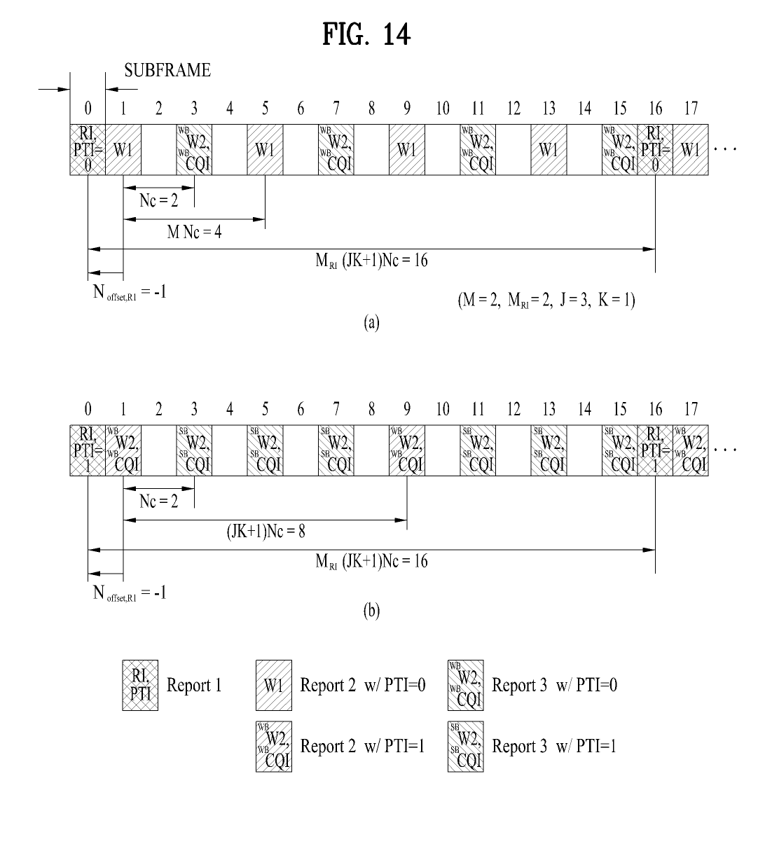

FIG. 14 is a diagram illustrating periodic reporting of CSI that has been discussed in an LTE-A system. When BS has 8 Tx antennas, in case of Mode 2-1, a precoder type indication (PTI) parameter as a 1-bit indicator is set, and a periodic reporting mode subdivided into two types according to a PTI value is considered, as illustrated in FIG. 15. In FIGS. 14, W1 and W2 indicate hierarchical codebook described with reference to Equations 8 and 9 above. When both W1 and W2 are determined, precoding matrix W completed by combining W1 and W2 is determined.

Referring to FIG. 14, In case of periodic reporting, different contents corresponding to Report 1, Report 2, and Report 3 are reported according to different reiteration periods. RI and 1-bit PTI are reported in Report 1. WB(WideBand) W1 (when PTI=0) or WB W2 and WB CQI (when PTI=1) are reported in Report 2. WB W2 and WB CQI (when PTI=0) or subband (SB) W2 and SB CQI (when PTI=1) are reported in Report 3.

Report 2 and Report 3 are transmitted in a subframe (for convenience, referred to as a first subframe set) with a subframe index satisfying (10*nf+floor(ns/2)−N offset, CQI) mod (NC)=0. N offset, CQI corresponds to an offset value for transmission of PMI/CQI illustrated in FIG. 9. In addition, Nc indicates a subframe interval between adjacent Reports 2 or Reports 3. FIG. 14 illustrates an example in which N offset, CQI=1 and Nc=2. The first subframe set is composed of subframes with an odd index. nf indicates a system frame number (or a radio frame index) and ns indicates a slot index in a radio frame. floor( ) indicates a rounddown function, and A mod B indicates a remainder obtained by dividing A by B.

Report 2 is located in some subframes in the first subframe set and Report 3 is located in the remaining subframes. In detail, Report 2 is located in a subframe with a subframe index satisfying (10*nf+floor(ns/2)−N offset, CQI) mod (H*Nc)=0. Accordingly, Report 2 is transmitted every interval of H*Nc, and one or more first subframes between adjacent Reports 2 are filled by transmitting Report 3. In case of PTI=0, H=M and M is determined via upper layer signaling. FIG. 14 illustrates a case of M=2. In case of PTI=1, H=J*K+1, K is determined via upper layer signaling, and J is the number of BPs. FIG. 14 illustrates a case of J=3 and K=1.

Report 1 is transmitted in a subframe with a subframe index satisfying (10*nf+floor(ns/2)−N offset, CQI-N offset, RI) mod (MRI*(J*K+1)*Nc)=0, and MRI is determined via upper layer signaling. N offset, RI corresponds to a relative offset value for RI. FIG. 14 illustrates a case of MRI=2 and N offset, RI=−1. According to N offset, RI=−1, transmission time for Report 1 and transmission time for Report 2 do not overlap each other. When a UE calculates RI, W1, and W2, RI, W1, and W2 are associated with each other. For example, W1 and W2 are calculated with dependence upon RI, and W2 is calculated with dependence upon W1. At a point of time when both Report 2 and Report 3 are reported after Report 1 is reported, a BS may know final W from W1 and W2.

Interference Cancellation Method

FIG. 15 is a diagram illustrating a general interference environment of a downlink system. Referring to FIG. 15, the cell A is a cell which is operated by a TP A, and UE A is a user equipment communicating with the TP A. Similarly, there is a Cell B and UE B for the adjacent TP B. The cell A and the cell B uses the same radio resource, so UE B receives interference from a UE located in cell boundary. Hereinafter, the cell A is definded as a serving cell, the TP A is defined as an interference cell, the TP B is defined as an interference TP, and the UE A is defined as a NAICS UE. NAICS UE increases the data receiving rate by removing the interference signal from the interfering cell. TP A and TP B may be homogeneous TP having same DL transmission power or heterogeneous TP having different DL transmission power.

In order to effectively eliminate the interference, NAICS UE has to know various IPs (interference parameters) for the interference signal. For example, in an independent NAICS environment from a TM (transmission mode), information on CFI (Control Format Indicator), MBSFN (Multimedia Broadcast multicast service Single Frequency Network) configuration, RI, CRS AP, Cell ID, Modulation Order, MCS, RNTI, TM is required. In case of an NAICS environment of CRS TM, information on PMI, Data to RS EPRE, PA, PB, System bandwidth, PDSCH allocation is required. In case of an NAICS environment of DM-RS TM, information on PDSCH bandwidth for DM-RS, Data to RS EPRE, PB, DMRS APs, nSCID, CSI-RS presence and their pattern, Virtual cell ID is required. Meanwhile, the serving cell may receive the IPs which are required to perform the NAICS from a neighboring cell via a backhaul.

The NAICS UE removes the interference signal by performing additional blind detection (BD) for some parameters and discovering every information required to cancel the interference PDSCH after receiving the interference information through the serving TP.

If the interference TP B performs eIMTA in the TDD system, the interference TP may use configuration different from UL/DL configuration used by the serving TP A. Considering this, NAICS UE operation will be defined. If the NAICS UE may know actual UL/DL subframe of the TP B, it is preferable that the UE performs NAICS as far as the TP B is DL subframe at the subframe for receiving a desired PDSCH. That is, the NAICS UE does not perform NAICS in case of UL subframe. This is because that the NAICS UE considered in the current LTE Rel-12 has been defined to have capability of removing interference for DL interference only at the time when DL data is received.

It is expected that more advanced NAICS UE may always remove interference regardless of UL/DL. In this case, NAICS may be performed through independent user equipment depending on whether the interference TP B performs UL service or DL service. As a result, in the eIMTA environment, it is necessary to know a type of subframe of the interference TP and apply NAICS suitable for the type of the subframe regardless of Rel-12 NAICS UE or more advanced NAICS UE.

However, since actual UL/DL configuration of the interference TP may be reconfigured through DCI at a minimum period of 10 ms, it is not preferable that the serving TP connected to a non-ideal backhaul notifies the UE of such information. Therefore, the NAICS UE receives information as to application of eIMTA of the interference TP, UL/DL configuration information included in SIB1 and flexible subframe information (semi static information, . . . ) from the base station. Then, it is necessary to newly define NAICS operation at the flexible subframe of the interference TP based on the received information.

1. UL/DL Configuration Parameter Signaling

The NAICS UE receives information as to application of eIMTA of the interference TP, UL/DL configuration information included in SIB1 of the interference TP and flexible subframe information of the interference TP from the base station. If a direct channel with the interference TP is formed, the NAICS UE may directly receive the corresponding information from the interference TP.

The flexible subframe information may be one of the followings.

1-1. Flexible Subframe Position of the Interference TP

Flexible subframe corresponds to UL or special SF which may be used by being exchanged with DL subframe.

It is notified in a bitmap format as to which subframe may be used as a flexible subframe in UL/DL configuration of SIB1 of the interference TP. For example, in case of 00010 01110, it is notified that the interference TP may use UL or special subframe by exchanging it with DL subframe at subframes 3, 6, 7 and 8.

1-2. DL Reference Configuration of the Interference TP (UE Specific RRC Signaling)

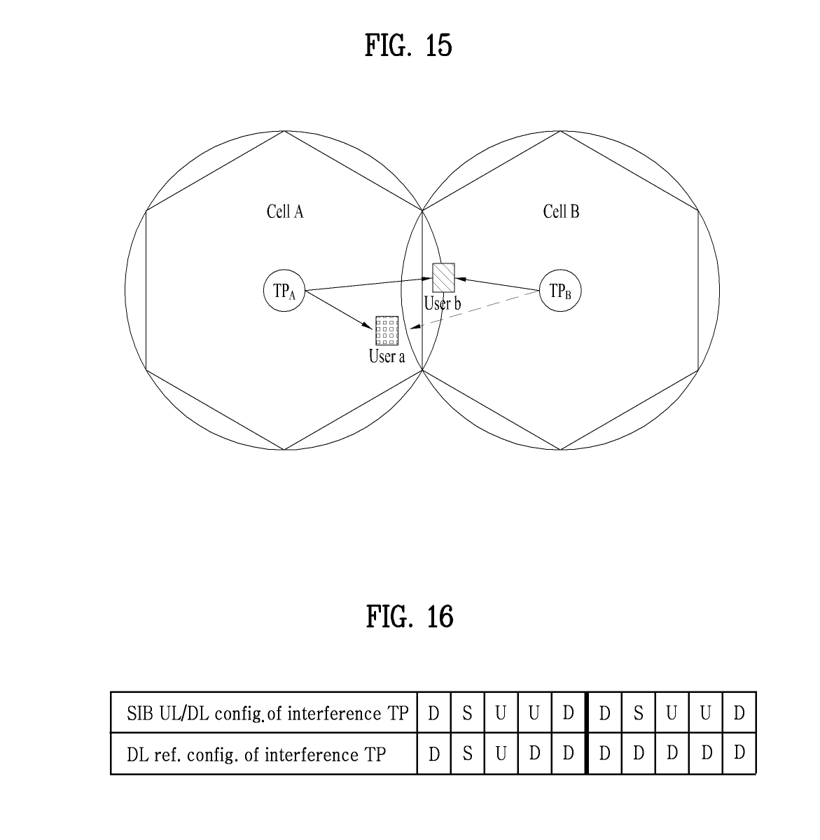

The UE compares DL reference configuration of the interference TP with SIB1 UL/DL configuration of the interference TP and identifies a subframe that may be used as the flexible subframe. Referring to FIG. 16, when SIB UL/DL configuration is S (special subframe) or U (Uplink subframe) but DL reference configuration is D subframe, the corresponding subframe is identified as the flexible subframe. That is, a subframe highlighted with yellow in the following example is identified as the flexible subframe.

1-3. Subframe Set Information

Subframe set has been introduced to identify CSI measurement between subframe sets having different interference features. The UE receives configurations of set 0 and set 1 from the serving TP, performs independent interference measurement in accordance with each set, and feeds CSI back. It is suggested to identify the flexible subframe of the interference TP from a static downlink subframe through reuse of the subframe set information. That is, the NAICS UE may identify the flexible subframe by receiving the configuration of set 0 corresponding to the static downlink subframe and the configuration of set 1 corresponding to the flexible subframe from the base station. At this time, the subframe set may be a subframe defined for eICIC or a subframe set defined for eIMTA. Also, if the subframe set defined for eICIC or eIMTA is reused, features (static/flexible) of each subframe set may be signaled from the serving TP.

1-4. Intended Subframe Configuration Information of the Interference TP (X2 Signaling Shared Between Base Stations)

In an eIMTA network, SIB1 UL/DL configuration information and intended subframe configuration information are shared between TPs through a backhaul. The intended subframe configuration is UL/DL configuration information that is likely to be actually used by a neighboring TP until a given timing point in the future. The serving TP notifies the NAICS UE of the intended subframe configuration, and the UE compares the SIB1 UL/DL configuration of the interference TP with the intended subframe configuration and identifies the flexible subframe position. For example, if a subframe designated as UL subframe in the SIB1 is defined as DL in the intended configuration, the corresponding subframe may be regarded as the flexible subframe.

2. UE Behavior

The NAICS UE that has received the above information through signaling identifies the flexible subframe of the interference TP and performs one of the following operations if the desired PDSCH is received at the corresponding subframe.

2-1. The UE does not Perform NAICS at the Flexible Subframe.

Since the UE does not know whether the interference TP performs DL transmission or UL reception, the UE receives the PDSCH by turning NAICS function off.

2-2. The UE Performs UL/DL BD at the Flexible Subframe.

The UE that knows CRS information of the interference TP takes correlation between the received signal and the interference CRS at a CRS RE and then determines UL/DL based on a size of detected energy. That is, the detected energy is great in case of DL but the detected energy is small due to CRS absence in case of UL, whereby UL/DL may be determined based on the above detected energy. If the corresponding SF is determined as DL, the UE performs NAICS operation. If the NAICS UE has capability of removing UL interference from the interference cell, the UE performs a suitable interference removal depending on UL/DL determination.

3. NAICS Parameter Set Per Subframe Set

For NAICS operation per subframe set suggested as above, the NAICS UE may receive parameter sets for a plurality of NAICSs from the serving TP through signaling.

The correlation between the parameter set for NAICS and the subframe set may be defined implicitly, or may be signaled by the serving TP. In accordance with the corresponding correlation, the NAICS UE may select the parameter set for NAICS to be applied per subframe set.

If the UL/DL configurations included in the SIB1 of the serving TP and the interference TP are the same as each other, UL/DL configuration of the interference TP may not be received.

Also, if the flexible subframe information is not transferred, the UE performs the operation of the above ‘2’ by considering all the flexible SFs available in the UL/DL configuration of the interference TP.

Additionally, if eIMTA operation is performed, interference parameters may be set differently in the static subframe set and the flexible subframe set due to different interference environments. Therefore, if the interference cell performs eIMTA operation, it is suggested that the serving TP signals the parameter set for a plurality of NAICSs (e.g., two NAICSs) to the NAICS UE and removes interference by using different parameter sets in accordance with features of the subframe set of the interference cell.

As an example of the present invention, a method for applying the above 1-3 is as follows. The NAICS UE may receive two subframe sets for eIMTA (or defined in Rel.12) from the serving TP through signaling, and may receive two parameter sets for NAICS through additional signaling. Afterwards, the NAICS UE may perform NAICS based on the correlation between the subframe set and the parameter set, which are signaled from the serving TP at the time when the corresponding subframe set is applied, (for example, when NAICS for a special subframe set is performed, a parameter set having the same index as the corresponding subframe set index may be applied).

If the UE may estimate UL/DL configuration of the interference TP as above, the estimated UL/DL configuration may be used for subframe restricted measurement for CSI calculation. Since features of the interference are varied depending on whether the interference TP is UL or DL, according to the current LTE spec, two subframe sets may be configured to perform interference measurement in each set, and CSI for each set is fed back independently based on the performed interference measurement. Also, the subframe set configuration is configured semi-statically through RRC.

However, in a state that UL/DL configuration of the interference TP may be varied dynamically like eIMTA, it may not be preferable that CSI is fed back for each subframe set fixed semi-statically. Therefore, it is preferable that the UE, which performs subframe restricted measurement, uses the subframe set flexibly depending on actual duplex direction of the interference TP without using the fixed subframe set. That is, the UE independently performs interference measurement at two sets like the existing manner, and independently feeds back CSI for each set based on the performed interference measurement. In this case, the UE may randomly configure two sets in accordance with duplex direction of BD without configuring the two sets through RRC. For example, if the UE detects DL of the interference TP, the UE sets the corresponding subframe to set 0, and if the UE detects UL, the UE sets the corresponding subframe to set 1.

Additionally, the base station may schedule or signal the UE that the set 0/1 has been managed as above.

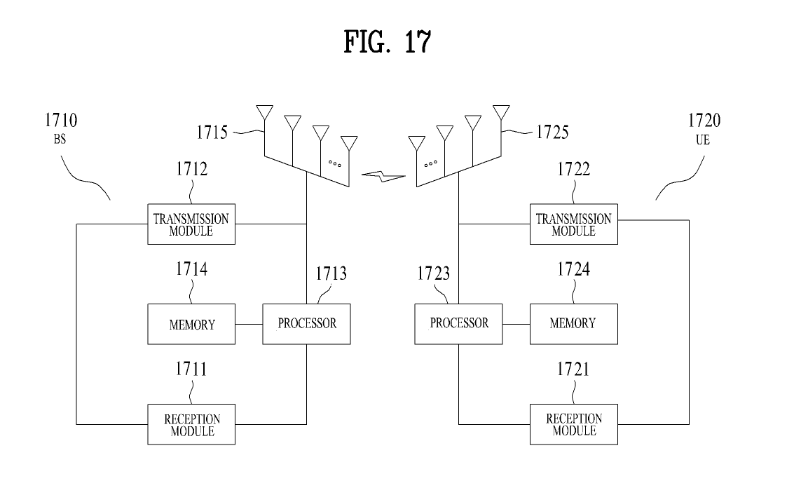

FIG. 17 is a diagram illustrating a base station and a user equipment, which may be applied to one embodiment of the present invention.

If a relay is included in a wireless communication system, communication in a backhaul link is performed between the base station and the relay and communication in an access link is performed between the relay and the user equipment. Accordingly, the base station or the user equipment as shown may be replaced with the relay depending on the circumstances.

Referring to FIG. 17, the wireless communication system includes a base station 1710 and a user equipment 1720. The base station 1710 includes a processor 1713, a memory 1714, and radio frequency (RF) units 1711 and 1712. The processor 1713 may be configured to implement procedures and/or methods suggested in the present invention. The memory 1714 is connected with the processor 1713 and stores various kinds of information related to the operation of the processor 1713. The RF unit 1716 is connected with the processor 1713 and transmits and/or receives a radio signal. The user equipment 1720 includes a processor 1723, a memory 1724, and radio frequency (RF) units 1721 and 1722. The processor 1723 may be configured to implement procedures and/or methods suggested in the present invention. The memory 1724 is connected with the processor 1723 and stores various kinds of information related to the operation of the processor 1723. The RF units 1721 and 1722 are connected with the processor 1723 and transmit and/or receive a radio signal. The base station 1710 and/or the user equipment 1720 may have a single antenna or multiple antennas.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

In the embodiments of the present invention, a specific operation described as being performed by the BS may be performed by an upper node of the BS. Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an eNode B (eNB), an access point, etc.

The embodiments according to the present invention can be implemented by various means, for example, hardware, firmware, software, or combination thereof. In a hardware configuration, the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, the embodiments of the present invention can be implemented by a type of a module, a procedure, or a function, which performs functions or operations described above. Software code may be stored in a memory unit and then may be executed by a processor.

The memory unit may be located inside or outside the processor to transmit and receive data to and from the processor through various means which are well known.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The above-described embodiments of the present invention can be applied to a wireless communication system such as a user equipment (UE), a relay, a base station (BS), etc.

What is claimed is:

1. A method for receiving a signal using NAICS (Network Assisted Interference Cancellation and Suppression) in a wireless access system supporting eIMTA (Enhanced Interference Management and Traffic Adaptation), the method performed by a user equipment and comprising:
receiving first information on uplink and downlink configuration of a neighbor cell and second information related with a flexible subframe of the neighbor cell; and
receiving the signal based on the first information and the second information.

2. The method of claim 1, wherein the second information includes a bitmap indicating flexible subframe position of the neighbor cell.

3. The method of claim 1, wherein the second information includes a downlink reference configuration to be compared with the uplink and downlink configuration of the neighbor cell.

4. The method of claim 1, wherein the second information includes a first subframe set information for flexible subframe and a second subframe set information for static downlink subframe.

5. The method of claim 4, further comprising:
receiving a first NAICS parameter set for the first subframe set information and a second NAICS parameter set for the second first subframe set information.

6. The method of claim 1, wherein the second information includes intended subframe configuration indicating subframes used by the neighbor cell until reference timing point.

7. The method of claim 1, wherein the flexible subframe indicates uplink subframe or special subframe which can be used by being exchanged with downlink subframe for the eIMTA.

8. A user equipment for receiving a signal using NAICS (Network Assisted Interference Cancellation and Suppression) in a wireless access system supporting eIMTA (Enhanced Interference Management and Traffic Adaptation), the user equipment comprising:
radio frequency (RF) units; and
a processor which is configured to:
receive first information on uplink and downlink configuration of a neighbor cell and second information related with a flexible subframe of the neighbor cell; and
receive signal based on the first information and the second information.

9. The user equipment of 8, wherein the second information includes a bitmap indicating flexible subframe position of the neighbor cell.

10. The user equipment of 8, wherein the second information includes a downlink reference configuration to be compared with the uplink and downlink configuration of the neighbor cell.

11. The user equipment of 8, wherein the second information includes a first subframe set information for flexible subframe and a second subframe set information for static downlink subframe.

12. The user equipment of 11, the processor configured to:
receive a first NAICS parameter set for the first subframe set information and a second NAICS parameter set for the second first subframe set information.

13. The user equipment of 8, wherein the second information includes intended subframe configuration indicating subframes used by the neighbor cell until reference timing point.

14. The user equipment of 8, wherein the flexible subframe indicates uplink subframe or special subframe which can be used by being exchanged with downlink subframe for the eIMTA.
